(19) United States
(12) Patent Application Publication
(10) Pub. No.: US 2022/0245653 A1
(43) Pub. Date: Aug. 4, 2022

(54) SYSTEMS AND METHODS FOR CROSS-CHANNEL MARKETING EXPERIMENTATION MANAGEMENT

(71) Applicant: Walmart Apollo, LLC, Bentonville, AR (US)

(72) Inventors: Xiaoyong Bai, Santa Clara, CA (US); Wei Shen, Pleasanton, CA (US); Qianqian Zhang, Castro Valley, CA (US); Boning Zhang, Santa Clara, CA (US)

(73) Assignee: Walmart Apollo, LLC, Bentonville, AR (US)

(21) Appl. No.: 17/163,538

(22) Filed: Jan. 31, 2021

(51) Int. Cl. G06Q 30/02; G06Q 10/06; G06F 16/23

(52) U.S. Cl. CPC G06Q 30/0201; G06F 16/2379; G06Q 10/06393; G06Q 30/0204

(57) ABSTRACT

A system including one or more processors and one or more non-transitory computer-readable media storing computing instructions configured to run on the one or more processors and perform: receiving, from a user, one or more pre-designed test parameters of an experiment; generating an audience list table comprising one or more identifications (IDs), wherein the one or more IDs link to one or more identification (ID) levels; removing, using identification (ID) mapping, each member of the audience who has an ID that does not satisfy one or more constraints of the one or more ID levels based on the one or more pre-designed test parameters; evaluating, using an evaluation algorithm, whether bias exists for each treatment group of two or more treatment groups; launching the experiment on the members remaining in the audience; and causing at least one result of the experiment to be displayed. Other embodiments are disclosed.

### TECHNICAL FIELD

This disclosure generally relates to cross-channel experimentation.

### BACKGROUND

Marketing channels conduct experiments for variants of treatments to different groups of users at a same time. Managing and tracking such experiments can be challenging and inefficient.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for creating a standardized web-based platform for conducting experiments across one or more channels, according to an embodiment;

FIG. 4 illustrates a flow chart for a method, according to an embodiment;

FIG. 5 illustrates a representative block diagram for creating a standardized web-based platform for conducting experiments across one or more channels, according to the embodiment of FIG. 3;

FIG. 6 illustrates a diagram of a heirarchical organizational structure, according to an embodiment;

FIG. 7 illustrates a flow chart for a method, according to another embodiment.

FIG. 8 illustrates a table diagram for a system, according to an embodiment;

FIG. 9 illustrates a table diagram for a system, according to an embodiment;

FIG. 10 illustrates a flow chart for a method according to an embodiment; and

FIG. 11 illustrates a flow chart for a method according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

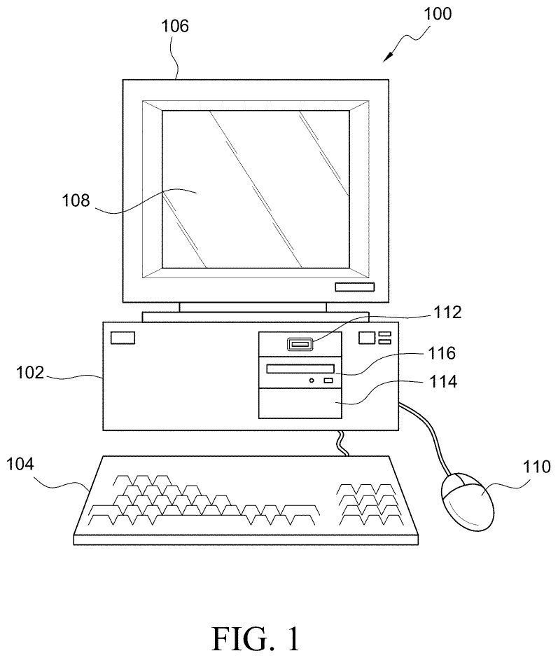

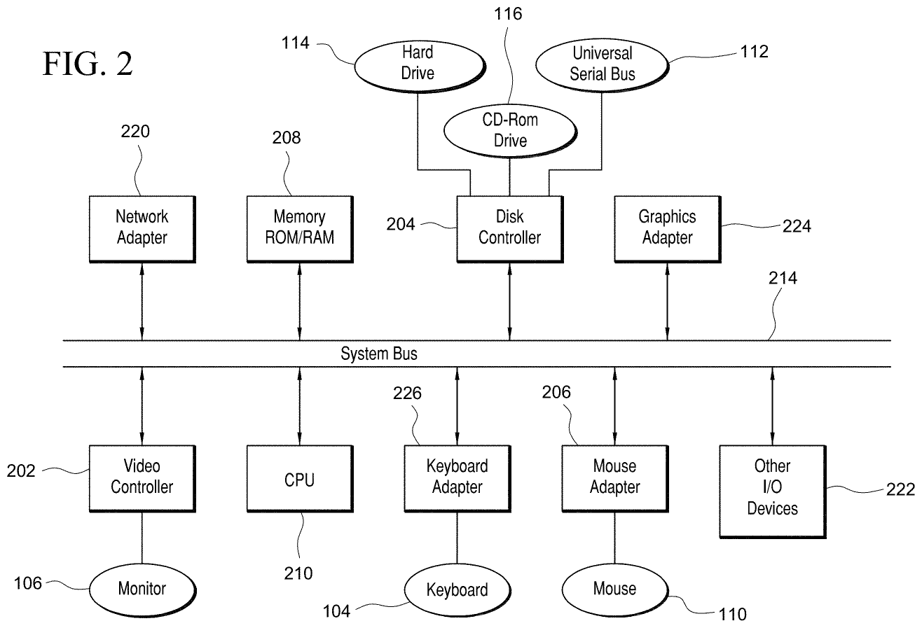

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

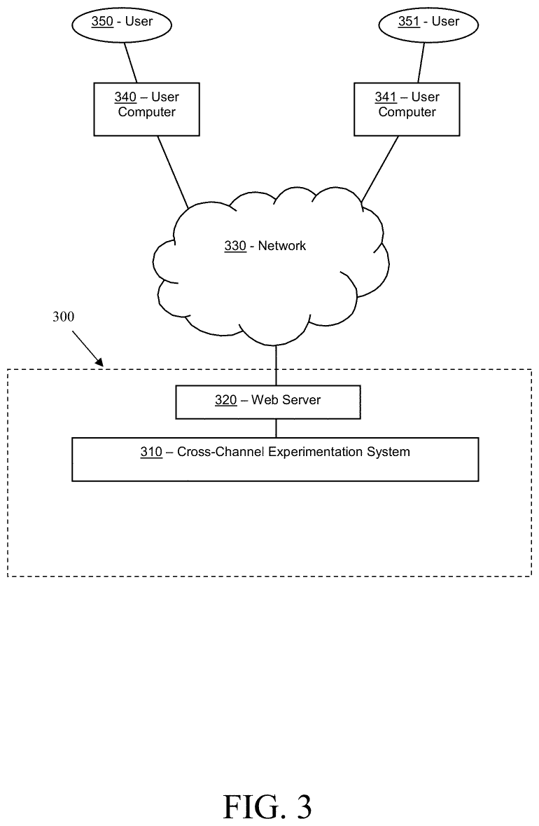

Turning ahead in the drawings, FIG. 3 illustrates a block diagram of a system 300 that can be employed for creating a standardized web-based platform for conducting experiments across one or more channels, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a cross-channel experimentation system 310 and/or a web server 320. Cross-channel experimentation system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, cross-channel experimentation system 310 and/or web server 320. Additional details regarding cross-channel experimentation system 310 and/or web server 320 are described herein.

In a number of embodiments, each of cross-channel experimentation system 310 and/or web server 320 can be a special-purpose computer programed specifically to perform specific functions not associated with a general-purpose computer, as described in greater detail below.

In some embodiments, web server 320 can be in data communication through Network 330 with one or more user computers, such as user computers 340 and/or 341. Network 330 can be a public network, a private network or a hybrid network. In some embodiments, user computers 340-341 can be used by users, such as users 350 and 351, which also can be referred to as customers, audience members, or data scientists, in which case, user computers 340 and 341 can be referred to as customer, audience member, or data scientist computers, respectively. In many embodiments, web server 320 can host one or more sites (e.g., websites) that allow users to browse and/or search for items (e.g., products), to add items to an electronic shopping cart, and/or to order (e.g., purchase) items, in addition to other suitable activities.

In some embodiments, an internal network that is not open to the public can be used for communications between cross-channel experimentation system 310 and/or web server 320 within system 300. Accordingly, in some embodiments, cross-channel experimentation system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

In many embodiments, cross-channel experimentation system 310 and/or web server 320 can each include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to cross-channel experimentation system 310 and/or web server 320, in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of cross-channel experimentation system 310 and/or web server 320. In a similar manner, the processors and/or the non-transitory computer-readable media can be local and/or remote to each other.

Meanwhile, in many embodiments, cross-channel experimentation system 310 and/or web server 320 also can be configured to communicate with and/or include one or more databases and/or other suitable databases. The one or more databases can include an item database that contains information about items or SKUs (stock keeping units), for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between cross-channel experimentation system 310 and/or web server 320, and/or the one or more databases, can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

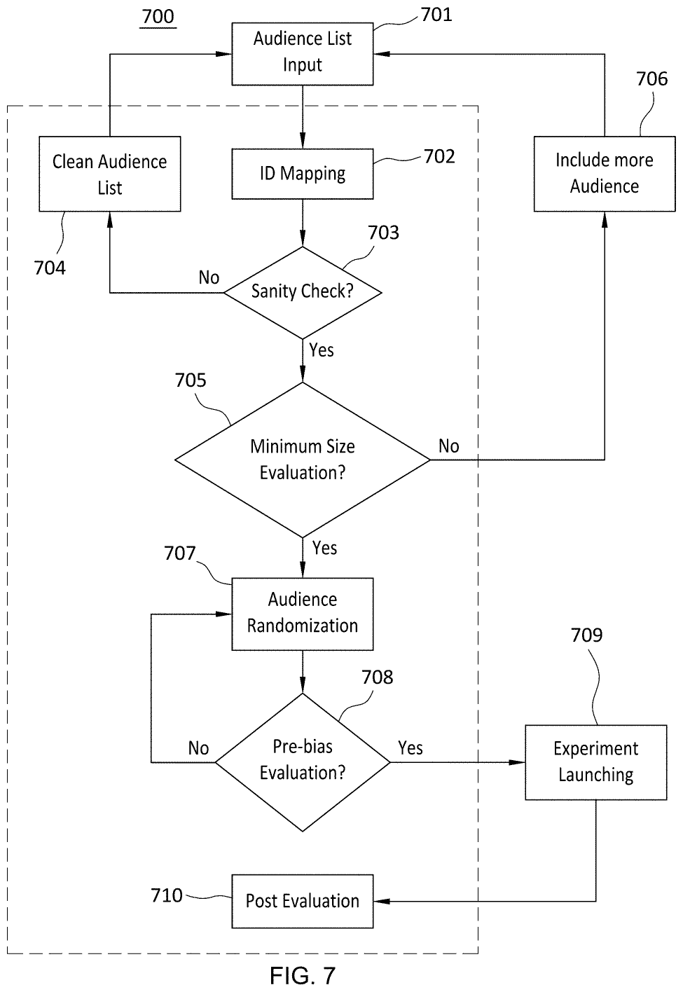

Jumping ahead in the drawings, FIG. 7 illustrates a flow chart for a method 700, according to another embodiment. In some embodiments, method 700 can be a method of automatically creating a standardized web-based platform for conducting experiments across one or more channels. Method 700 is merely exemplary and is not limited to the embodiments presented herein. Method 700 can be employed in many different embodiments and/or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped. In several embodiments, system 300 (FIG. 3) can be suitable to perform method 700 and/or one or more of the activities of method 700.

In these or other embodiments, one or more of the activities of method 700 can be implemented as one or more computing instructions configured to run at one or more processors and configured to be stored at one or more non-transitory computer-readable media. Such non-transitory computer-readable media can be part of a computer system such as cross-channel experimentation system 310 and/or web server 320. The processor(s) can be similar or identical to the processor(s) described above with respect to computer system 100 (FIG. 1).

Referring to FIG. 7, method 700 can include a block 701 (audience list) of inputting an audience list into a cross-channel experimentation system, such as an experimental platform that can be similar or identical to cross-channel experimentation system 310 (FIG. 3). In various embodiments, block 701 can be processed by block 702 (ID mapping) to locate different levels of information about the members as potential audience list members. In some embodiments, after block 702 verifies the level of information that can be received from each potential member, block 703 (sanity check) performs a check on the potential member of the audience list to be certain it is the correct person who has the correct contact information. In several embodiments, if the sanity check clears the potential audience member, the information about the potential audience member can proceed to block 705 (minimum size evaluation), for evaluation of the number of potential members of an audience list. In some embodiments, should the audience size need to be increased, block 706 can start the selection process to add other potential candidates to the audience list.

In some embodiments, if block 703 (sanity check) rejects a potential audience member, block 704 can receive the rejected information and clean the audience list to remove the audience member as method 700 proceeds. In several embodiments, once an audience size reaches a number that can be statistically significant as a whole and/or for each of the treatment groups that are intended to be used for the experiment, method 700 continues from block 705 (minimum size evaluation) with block 707 (randomization) that can split the audience into two or more treatment groups. In various embodiments, block 708 (pre-bias evaluation) can conduct an pre-bias evaluation of each treatment group to confirm that no pre-bias exists in each of the treatment groups so that the remaining members on the audience list can be used to launch the experiment using block 709 (launch). In some embodiments, if bias exists in any of the treatment groups, the audience list can be re-cycled back to block 707 (randomization) to reshuffle the audience members to exclude the risk of bias in the previously form treatment groups.

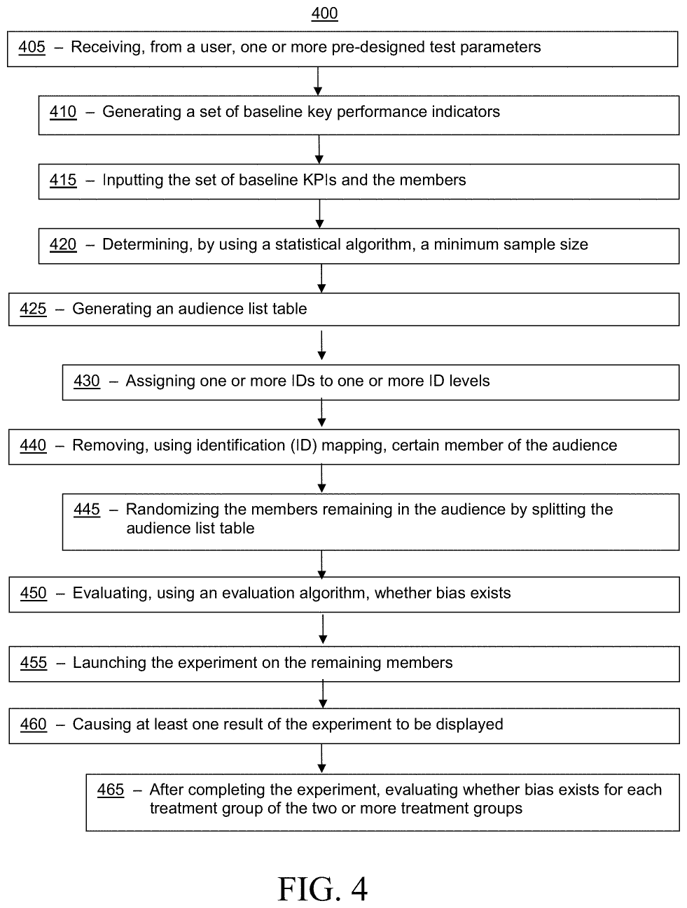

Turning back in the drawings, FIG. 4 illustrates a flow chart for a method 400, according to another embodiment. In some embodiments, method 400 can be a method of automatically creating a standardized web-based platform for conducting experiments across one or more channels. Method 400 is merely exemplary and is not limited to the embodiments presented herein. Method 400 can be employed in many different embodiments and/or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as cross-channel experimentation system 310 and/or web server 320. The processor(s) can be similar or identical to the processor(s) described above with respect to computer system 100 (FIG. 1).

Referring to FIG. 4, method 400 can include a block 405 of receiving, from a user, one or more pre-designed test parameters of an experiment designed to test at least one marketing strategy for at least one marketing channel.

In several embodiments, method 400 also can include a block 410 of generating a set of baseline key performance indicators (KPIs).

In many embodiments, method 400 additionally can include a block 415 of inputting the set of baseline KPIs and the remaining members in the audience list table.

In some embodiments, method 400 further can include a block 420 of determining, by using a statistical algorithm, a minimum sample size of the audience based on the set of baseline KPIs and the remaining members in the audience list table. In several embodiments, a probability of a false positive for the minimum sample size can be below 5 percent.

In several embodiments, determining a minimum sample size for an experiment can be based on using an algorithm, as expressed:

$$Algorithm 1.0 \text{:}$$

$$P = ( c * ( p 0 + delta p ) + ( 1 - c ) * p 0 ) ;$$

$$A = {Z}_{( 1 \text{-} 1 / alpha )} * ( \sqrt{P ( 1 - P ) * ( \frac{1}{c} + \frac{1}{1 - c} )} \\ B = {Z}_{{( beta )}^{*}} \\ \sqrt{( p 0 + delta p ) * \frac{1 - ( p 0 + delta p )}{c} + p 0 * ( 1 - p 0 ) / ( 1 - c )} \\ C = {( delta p )}^{2} \\ N = {( A + B )}^{\hat{}} 2 / C$$

As below specified, P, A, B, C can inter-computation denominations which do not carry specific meanings, rather they are simply symbols which make the representation and computation above more easily explained.
Where P, A, B, C refer to denominations for inter-computation products. In some embodiments, inputs to Algorithm 1 can include the following:
% of members in the audience in a test group (i.e., test group audience counts/total audience counts in the experiment): c % of members in the audience in a control group (i.e., control group audience counts/total audience counts in the experiment): 1-c
a KPI baseline can be calculated based on a supplied segment list: p0.

In several embodiments, the KPI baseline can refer to a status quo KPI before the experiment can be performed (if nothing is done to the audience). For example, a KPI baseline can be a conversion rate, such as: (a number of people who ordered the item)/(the number of total people in the audience list (N₀)).
a statistical significance level: a.

In some embodiments, a statistical significance level “a” can refer to a chance of receiving a false positive risk, where the value can be discretionary by the user. In various embodiments, a risk of achieving a false positive can include 5% for general use.
a statistical power: b.

(1-b) refers to the chance (e.g., risk) of achieving a false negative. The value could be at the discretion of a user. In general a rule of thumb is 80%.
an expected lift refers to a key KPI measurement (e.g., a conversion rate) from the treatment group compared with control: delta p.

In some embodiments, an expected lift can refer to an increase as the result of the treatment (p1−p0=delta p).

In several embodiments, an output for Algorithm 1.0 can include determining a minimum sample size: N.

In various embodiments, the platform can compare the output N vs. the size of the supplied audience list N₀: If N>N₀, then the system can accept the recommended minimum size of the audience list. In several embodiments, a recommended minimum size of an audience list can cause the user to increase or decrease a segment of a size of an audience in order to achieve a level of robustness for an experiment that can yield statistically significant results.

In a number of embodiments, a test subject sample size can be the number of experimental units included in an experiment, thus the size can be one of the first practical steps to achieve in designing an experiment. In some embodiments, an advantage of recommending a minimum sample size can assist a user designing the experiment and an increased level of control to minimize a risk of reporting a false-negative finding and/or to predict or estimate a level of precision given the design of the experiment.

In various embodiments, method 400 also can include a block 425 of generating an audience list table comprising one or more identifications (IDs) for each member of an audience. In some embodiments, the one or more IDs can link to one or more identification (ID) levels.

In several embodiments, a user using the cross-channel experimentation system as an experimentation platform also can provide an estimated size of audience list that can be checked by the system. In many embodiments, assigning members into different experimentation treatment groups, i.e., groups that would receive various versions of marketing strategies (e.g., different version of creatives/promotions etc.) can be dependent on the subject matter being studied by the experimental design. In various embodiments, in order for each audience list to be free of duplicated records, a primary key can be identified and input to the experimentation platform. In some embodiments, a primary key can be a special relational database table column (or combination of columns) designated to uniquely identify each table record. In several embodiments, a table cannot have more than one primary key. In various embodiments, a primary key contains a unique value for each row of data and cannot contain null values. In some embodiments, every row has a primary key value. In several embodiments, a primary key can utilize one or more fields already present in the underlying data model, or a specific extra field can be created to be the primary key.

In some embodiments, an audience list can contains IDs for each member based on an “audience segment of interests.” In several embodiments, an audience segment of interests can be determined by the data scientists and marketing associates based on user (e.g., customer) values. For example, an audience segment of interests can include members of the audience that purchased an item, users who purchased an item after viewing an advertisement, etc.

In some embodiments, an audience segment of interests can serve as an input to the experiment platform where the platform can conduct the following: 1) generate baseline KPIs which can further feed into the minimum size evaluation process as inputs; 2) compare the audience list's size (e.g., N₀) with the minimum sample size output by the platform to determine whether the audience list can be used for an experiment; and 3) randomize the audience list into different treatment groups (i.e., a test group and a control group).

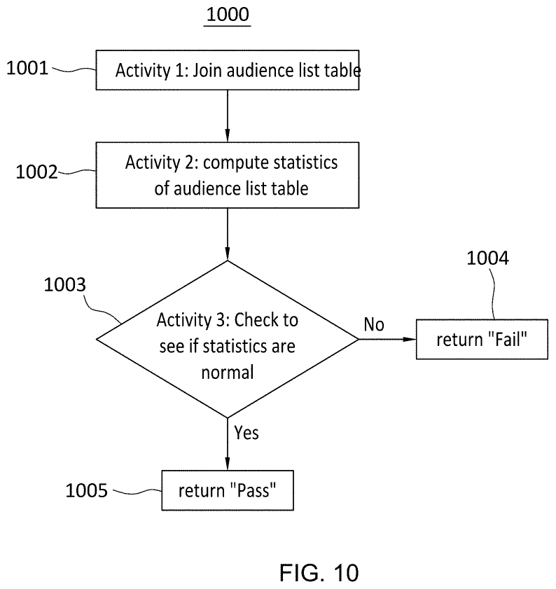

Jumping ahead in the drawings, FIG. 10 illustrates a flow chart for a method 1000, according to another embodiment. In some embodiments, method 1000 can be part of a method of automatically creating a standardized web-based platform for conducting experiments across one or more channels. Method 1000 is merely exemplary and is not limited to the embodiments presented herein. Method 1000 can be employed in many different embodiments and/or examples not specifically depicted or described herein. In some embodiments, the procedures, the processes, and/or the activities of method 1000 can be performed in the order presented. In other embodiments, the procedures, the processes, and/or the activities of method 1000 can be performed in any suitable order. In still other embodiments, one or more of the procedures, the processes, and/or the activities of method 1000 can be combined or skipped. In several embodiments, system 300 (FIG. 3) can be suitable to perform method 1000 and/or one or more of the activities of method 1000.

In these or other embodiments, one or more of the activities of method 1000 can be implemented as one or more computing instructions configured to run at one or more processors and configured to be stored at one or more non-transitory computer-readable media. Such non-transitory computer-readable media can be part of a computer system such as cross-channel experimentation system 310 and/or web server 320. The processor(s) can be similar or identical to the processor(s) described above with respect to computer system 100 (FIG. 1). As will be evident from the description below, method 1000 in FIG. 10 can include portions of blocks 425, 430, 440, 445, and 450 in FIG. 4, or vice versa.

In FIG. 10, method 1000 can include several activities that can map IDs to members. In several embodiments, Method 1000 can include a block 1001 (activity 1), block 1002 (activity 2), block 1003 (activity 3), block 1004 (return “fail”) and/or block 1005 (return “pass”).

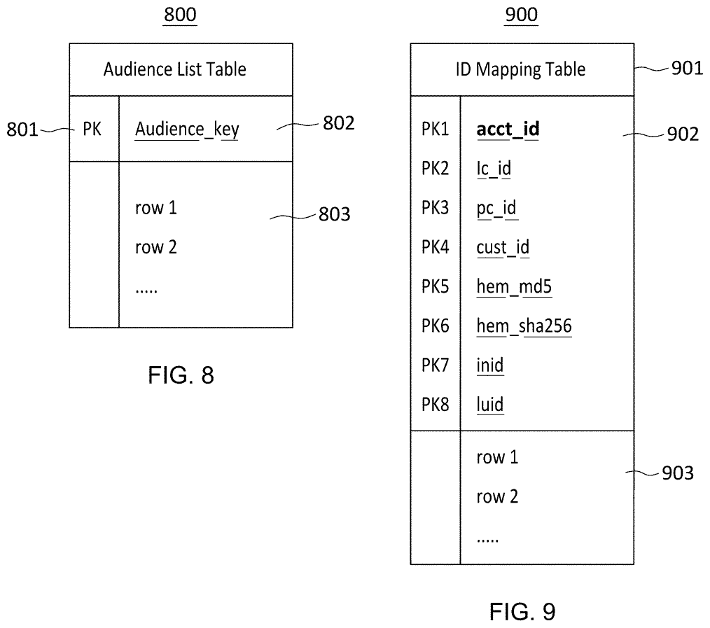

In some embodiments, block 1001 can perform an activity of joining an audience list table (FIG. 8) with ID mapping table (FIG. 9) to retrieve additional audience IDs for members of the audience. In several embodiments, each level of ID can include different levels of information about a potential audience member where an experimental design can include certain demographics for an audience that may not be available via a current level of ID for a potential member of an audience. Block 1002 can perform an activity of computing statistics for each audience list table using input such as 1) a total number of rows, 2) a total number of distinct IDs, and 3) a total number of null IDs. Block 1003 can perform a check that the output of block 1002 indicates that the treatment groups include randomness or not. In several embodiments, when the output of block 1003 indicates that bias exists within a treatment group, the treatment group(s) are rejected by block 1004 for further processing. In some embodiments, when the output of block 1003 indicates that no bias exists, then that audience list can be proceed to block 1005.

Returning to FIG. 4, in several embodiments, method 400 further can include a block 430 of assigning the one or more IDs to the one or more ID levels. In some embodiments, the ID levels are categorized into one or more hierarchical levels in a hierarchical structure. In various embodiments, block 430 can include each ID in a higher hierarchical level that can map to one or more IDs in a lower hierarchical level. In several embodiments, block 430 can include each ID in a lower hierarchical level that can map at most to one ID in a higher hierarchical level. In various embodiments each hierarchical level comprises a same ID hashed in a different format. In some embodiments, each ID level is linked to a particular algorithm.

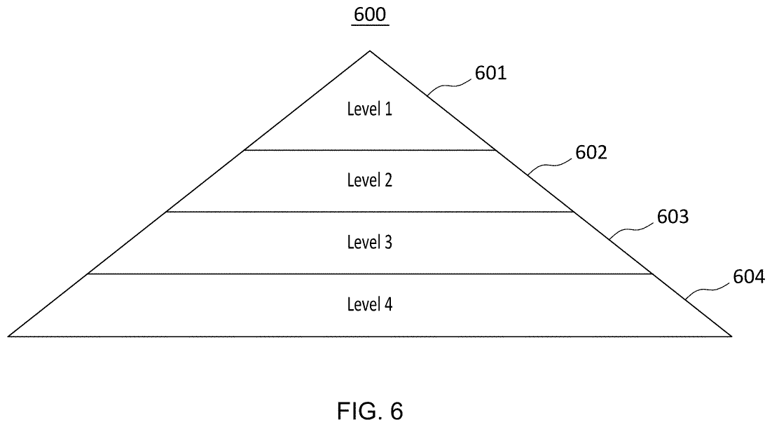

Jumping ahead in the drawings, FIG. 6 illustrates a hierarchical organizational structure 600, according to an embodiment. Hierarchical organizational structure 600 can illustrate various types of IDs as organized in a hierarchical structure such as the pyramid shape shown in FIG. 6. Hierarchical organizational structure 600 can include a top or highest hierarchical level or level 1 (household ID (luid)), a level 2 (individual ID, (inid)), a level 3 (email ID, (xxx_md5, xxx_sha256), and a bottom or lowest hierarchical level or level 4 (account ID (acct_id, lc_id, pc_id, cust_id)). In many embodiments, ID types in the same level can be identical, i.e., they can be the same ID hashed in a different format. For example, xxx_md5 can be a hashed email with an md5 algorithm, while xxx_sha256 can be the hashed email with a sha256 algorithm.

In various embodiments, an ID in a higher level of the hierarchy can map to multiple IDs in a lower level of the hierarchy, while each ID in a lower level of the hierarchy can at most map to one ID in a higher level of the hierarchy. For instance, a household may contain multiple individual IDs, while an individual can only belong to only one household.

In several embodiments, different types of IDs can be linked to different data in a database. For example, (1) an Account ID can be linked to transactions data including orders, items, gross merchandise value, etc., (2) an email ID can be linked to email recipients, responses and subscriptions, etc., and/or (3) an Individual ID can be linked to payment data.

Returning to FIG. 4, the one or more ID levels of block 430 can include user account identification (ID) linked to historical transaction data. In some embodiments, the one or more ID levels can include an email identification (ID) linked to at least one household, wherein the at least one household comprises one or more users. In several embodiments, the one or more ID levels can include a method of payment linked to the at least one household.

In some embodiments, method 400 also can include a block 440 of removing, using identification (ID) mapping, each member of the audience who has an ID that does not satisfy one or more constraints of the one or more ID levels based on the one or more pre-designed test parameters. In several embodiments, using the ID mapping of block 440 can include mapping a primary key for the audience list table to each of the one or more IDs for respective members of the audience.

In several embodiments, an audience list table also can be provided as input and can be a database table containing a list of multiple types of IDs. For example, a single audience list table can include more than 3 million emails in a certain format, such as “xxx_md5”, or another audience list table can contain 5 million emails with an email format such as “inid.”

In various embodiments, one purpose behind the ID mapping process can be to find and attach all of the other types of IDs that can be mapped to a member (e.g., customer) listed in the audience list table. For example, ID mapping can find and attach a specific type of ID that exists for each potential member of the audience size, such as “luid”, “inid”, “xxx_256,” “acct_id”, “lc_id”, “pc_id”, or “cust_idl”, where 3 million potential audience members ID with an xxx_md5 email format contained in the audience list table indicates a certain level of information can be retrieved for each member of the 3 million.

In many embodiments, there can be more than one benefit of the ID mapping process. In several embodiments, given a certain type of ID, some level of data can be retrieved from a database, however to retrieve higher levels of data, a next level type of IDs can be requested by third party vendors. ID mapping can attach all types of IDs to each customer so that the system can fetch all types of data. For example, if given only one type of ID, such as “xxx_md5”, it can present challenges or restrictions to fetch the requisite data needed from another level due to the hierarchical limitations on mapping to each level. This situation can pose problems for filling a potential audience size when attempting to retrieve certain data levels that match the parameters of an experimental design. In such a case, a potential qualified member can be excluded from the potential audience list. In some embodiments, ID mapping can attach account IDs and then link them to “xxx_md5”. In this manner, all members with this account ID can be included, and transaction data from such members can be fetched. In a number of embodiments, audience members can be selected from data information matching demographics, transaction data, and other data matching particular test design parameters that are requested to be tested. In many embodiments, members of an audience can be sent promotions and/or advertisements as part of an experimental test design. In several embodiments, members of an audience can be unaware they are participating in an experimental design.

In some embodiments, another benefit of the ID mapping process can be in a randomization activity (e.g., randomly splitting customers into several groups based on a different type of ID than the type provided by the user). For example, consider the case where members of the audience can be split into groups with a level of household IDs. However, the audience list table contains only hashed email IDs and household IDs. In these cases, the ID mapping can retrieve household IDs that can be used for randomization.

Jumping ahead in the drawings, FIG. 8 illustrates an exemplary audience list table 800. Audience list table 800 can include key 801 (primary key), key 802 (audience_key), and key 803 (rows). In several embodiments, key 802 can include an audience key that can be a type of ID from the ID space (e.g., acct_id, ic_id, pc_id, etc.) In some embodiments, primary keys can be generated randomly to be randomly selected to ensure randomness in the selection of the treatment groups and the post evaluation groups. Audience list table 800 can be mapped to ID numbers in FIG. 9, below

Turning ahead in the drawings, FIG. 9 illustrates an exemplary ID mapping table 900. ID mapping table 900 can include list 901 (IDs), table 902 (primary key ID types), and row 903 (rows). In several embodiments, primary keys in table 902 can match primary keys 801 (FIG. 8). In some embodiments, primary keys (e.g., PK1, PK2, PK3, etc.) in table 902 can be associated with an ID level. In some embodiments, an audience key type can be a type of ID from the ID space. In many embodiment, the primary keys in the block 901 can form the ID space.

Returning to FIG. 4, in various embodiments, method 400 further can include a block 445 of, before evaluating whether pre-existing bias exists, randomizing the members remaining in the audience by splitting the audience list table into the two or more treatment groups. In some embodiments, the randomizing of block 445 can comprise automatically identifying, using a randomization key, the members remaining in the audience. In several embodiments, audience splitting and randomization can be performed using one or more activities. The one or more activities can be expressed as follows:

Activity 1: Input Percentages for Each Group.

For example, for one control group and one test group, if a percentage of the control group is c, then the percentage of the test group will be 1-c.

In many embodiments, there can be more than two groups in an experiment, normally there is one control group and one or more test groups. In some embodiments, users and/or data scientists can have different strategies for different experimental designs, thus an advantage of this feature is that it can provide data scientists the flexibility to input a number of groups, the percentages for each group, and a randomization key according to experimental strategies. In several embodiments, the system can include a frontend User Interface (UI) where users (e.g., data scientists) can input numbers and/or parameters. Such a configuration can be recorded in a relational database for future reference and later use.

Activity 2: Check Percentages

In various embodiments, after configuring the percentages for groups in an experiment, the system can check the configuration to verify that: (1) there is at least one test group and (2) a sum of the percentages for all groups are 100%. In some embodiments, when the above two requirements can be violated, the system cannot accept the configuration to allow users to restart building a design and/or allow time to correct the configurations.

Activity 3: Select Distinct Randomization Key (ID) from an Audience List Table

In several embodiments, an audience list table can be a pool of potential users (e.g., customers) that can be split into a control group and/or test groups. In some embodiments, members of an audience list can be unaware they are participating in an experimental design in that each member can be selected based on information in multiple IDs.

In several embodiments, once a user submits an experimental design, the system can automatically identify and select distinct audiences from the provided audience table by a randomization key generated by the system. The selected distinct randomization keys can be a unique set on which the system (e.g., platform) can automatically conduct audience splitting. In some embodiments, a randomization key can be configured by to help identify distinct audiences.

Activity 4: Sort Randomization Key in a Random Order

In many embodiments, in order not to introduce bias to the treatment (e.g., experiment) groups, the methodology of audience splitting used by the system can be based on randomization. In several embodiments, the system can shuffle the distinct audiences/randomization keys selected from Activity 1. In some embodiments, a system can assign a machine-generated random number for each distinct randomization key. In various embodiments, as a result, all distinct randomization keys can be ordered by the random number to be ready for splitting at a future date. In a number of embodiments, randomization can avoid bias in the generated groups.

Activity 5: Distribute the Sorted Randomization Keys in Groups with the Percentages Specified in Activity 1.

In a number of embodiments, given the percentages for each group from activity 1, the randomly sorted randomization keys/audiences can be distributed into groups. For example, suppose there are 100 distinct randomization keys which are sorted by random numbers, and distributed in 3 groups with percentages as 33%, 33%, and 34%, respectively. Then assign the first 33 randomization keys into a control group, the second 33 randomization keys into test group 1, and the remaining in test group 2. No bias can be introduced in the distribution step, because the randomization keys can be ordered by random numbers.

Activity 6: Distribute Audiences into Groups by Respective Randomization Keys.

In several embodiments, after randomization keys can be distributed randomly into groups, corresponding audiences can be automatically distributed into groups with their randomization keys, since an audience and a randomization key are 1 to 1 mapped.

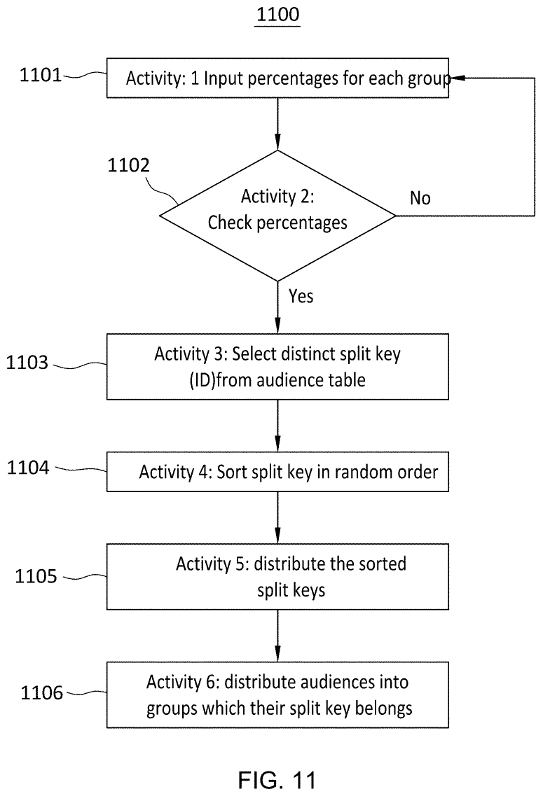

Jumping ahead in the drawings, FIG. 11 illustrates a flow chart for a method 1100, according to another embodiment. In some embodiments, method 1100 can be part of a method of automatically creating a standardized web-based platform for conducting experiments across one or more channels. More specifically, method 1100 can include additional details for block 445 (FIG. 4). Method 1100 is merely exemplary and is not limited to the embodiments presented herein. Method 1100 can be employed in many different embodiments and/or examples not specifically depicted or described herein. In some embodiments, the procedures, the processes, and/or the activities of method 1100 can be performed in the order presented. In other embodiments, the procedures, the processes, and/or the activities of method 1100 can be performed in any suitable order. In still other embodiments, one or more of the procedures, the processes, and/or the activities of method 1100 can be combined or skipped. In several embodiments, system 300 (FIG. 3) can be suitable to perform method 1100 and/or one or more of the activities of method 1100.

In these or other embodiments, one or more of the activities of method 1100 can be implemented as one or more computing instructions configured to run at one or more processors and configured to be stored at one or more non-transitory computer-readable media. Such non-transitory computer-readable media can be part of a computer system such as cross-channel experimentation system 310 (FIG. 3) and/or web server 320 (FIG. 3). The processor(s) can be similar or identical to the processor(s) described above with respect to computer system 100 (FIG. 1).

Referring to FIG. 11, method 1100 can include a block 1101 of receiving input percentages for each group where the percentages can be generated by the system for complete randomness of each treatment group to avoid bias. In some embodiments, block 1102 can perform a percentage check on the output of block 1101, if the percentage check passes, then the output data can be moved forward to block 1103, and if the percentage check does not pass, the method 1100 can revert back to and repeat block 1101. In several embodiments, block 1103 can perform activity 3 of selecting distinct split key (ID) from an audience table. Such an audience table can be similar or identical to audience table 800 (FIG. 8). In some embodiments, method 1100 can perform activity 1104 of sorting split keys in a random or. In various embodiments, method 1100 can perform activity 1105 of distributing the sorted split keys into groups with the percentages specified in block 1101. In some embodiments, method 1100 can perform an activity 1106 of distributing audiences into groups associated with their respective split key.

Returning to FIG. 4, in several embodiments, method 400 can include a block 450 of evaluating, using an evaluation algorithm, whether bias exists for each treatment group of two or more treatment groups created from members remaining in the audience after removing certain members of the audience. In various embodiments, using the evaluation algorithm can include inputting a respective number of success events from a first treatment group and a second treatment group. In some embodiments, using the evaluation algorithm also can include outputting a value level for evaluating whether the bias exists for the first treatment group and the second treatment group.

In some embodiments, a pre-bias evaluation can be conducted before the experiment launches, to evaluate whether any statistical significance exists across experimentation groups to ensure that the makeup of each group can be random. For example, performing this pre-bias evaluation ensures that comparing the experimental results from each of the groups is like comparing apples to apples.

In several embodiments, a post-evaluation also can be conducted after the experiment launched to evaluate, whether any statistical significance exists across experimentation groups is observed.

In various embodiments, both the pre-bias evaluation and the post-evaluation can be similar in that each evaluation tests whether bias exists in groups before the launch and whether the groups remained random after the experiment. In some embodiments, both the pre-bias evaluation and the post-evaluation can employ the same methodologies including using the same algorithm 2.0. In some embodiments, the same methodologies can include to sample, test and to detect the mean.

In many embodiments, algorithm 2.0 for both algorithms can be used to test for bias, as expressed:

$$Algorithm 2.0 \text{:}$$

$$P 0 = ( x 1 + x 2 ) / ( n 1 + n 2 )$$

$$Z = \frac{( \frac{x 1}{n 1} - \frac{x 2}{n 2} )}{\sqrt{p 0 * ( 1 - p ) ( \frac{1}{n 1} + \frac{1}{n 2} )}}$$

where the inputs can include:
A number of success events from test group: x1 (success events could be a number of people who purchased, a number of people who converted, etc.)
A number of success events from control group: x2
Size of test group: n1
Size of control group: n2
Statistical significance level: a.

In several embodiments, statistical significant level “a’ can include a percentage of risk (e.g., chance) of a false positive. In some embodiments, a value could be at the user's discretion but a rule of thumb can be 5% for general use.

Compare |Z| to |Z_{a/2}|

In some embodiments, if the absolute value of Z calculated in Algorithm 2 is greater than Z score at (a/2) level, then the difference that can be observed in a number of success events between test and control groups cannot be attributed to random events. In several embodiments, when this phenomenon shows in a pre-bias evaluation, it can suggest the randomization process selecting a test group and control group failed. In various embodiments, the audience list can restart the process of randomization and re-perform the randomization. If this phenomenon shows up in a post-evaluation, it can indicate that the experimental treatment did impose an impact on the audience, which caused differences in the test and control groups.

In many embodiments, if the absolute value of Z calculated in Algorithm 2 is smaller than Z score at (a/2) level, then the treatment group can be the same as the control group. In some embodiments, such a scenario can be favored in a pre-bias evaluation as it can suggest that no difference between the groups exists prior to the experiment launch. In several embodiments, if this scenario exists in the post-evaluation, it can indicate that the experiment's treatment does not have an impact on the audience groups.

In various embodiments, the z* score can be calculated on pre samples and post samples as an indication of whether the observed difference in treatment groups' can be statistically significant or not.

In a number of embodiments, a pre-bias evaluation and post effect evaluation can utilize the same algorithm to compare the differences in main KPIs across different treatment groups. In some embodiments, if there are multiple test groups, then each test group can be compared with the control group.

In several embodiments, a difference between a pre-bias evaluation and post effect evaluation can be that the data used for the 2 evaluations can differ at the respective time ranges. For example, if the experiment launched in 1/1/2021, then for pre-bias evaluation, the data range needs to be prior to the launch date to make sure the test group and control group are truly randomized without prior bias. An example time period to be used could be 12/1/2020-12/31/2020 for pre-bias evaluation. Similarly, the data used for post effect evaluation must be a time period post the launch date. In some embodiments, a post evaluation can start testing at a post effect N1e week after the experiment launch date. In the above example, it could be 1/8/2021-1/20/2021. The end date (1/20/2021) of the time range for the post effect evaluation is flexible and can be determined by the data scientist depending on how long the treatment group's effect would last.

In some embodiments, method 400 can include a block 455 of launching the experiment on the members remaining in the audience.

In various embodiments, method 400 can include a block 460 of causing at least one result of the experiment to be displayed on at least one user interface of at least one user electronic device.

In a number of embodiments, method 400 can include a block 465 of, after completing the experiment, evaluating whether the bias exists for each treatment group of the two or more treatment groups. As noted above, this post-experiment evaluation can include repeating the pre-experiment evaluation.

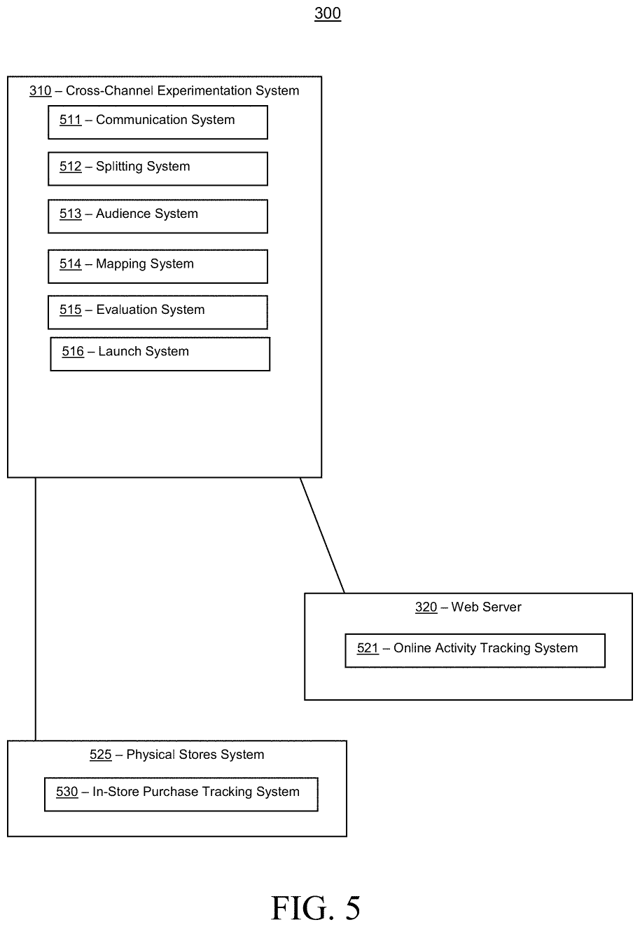

Turning to the next drawing, FIG. 5 illustrates a block diagram of system 300. As indicated previously with respect to FIG. 3, system 300 can include cross-channel experimentation system 310 and web server 320. In a different embodiment, system 300 can include cross-channel experimentation system 310, and web server 320 can be separate from system 300. In other embodiments, a physical stores system 525 can be part of system 300 or can be separate from system 300, regardless of whether web server 320 is part of system 300.

Each of cross-channel experimentation system 310, web server 320, and physical stores system 525 is merely exemplary and is not limited to the embodiments presented herein. Each of cross-channel experimentation system 310, web server 320, and physical stores system 525 can be employed in many different embodiments or examples not specifically depicted or described herein. In some embodiments, certain elements, components, or systems of each of cross-channel experimentation system 310, web server 320, and physical stores system 525 can perform various procedures, processes, and/or acts. In other embodiments, the procedures, processes, and/or acts can be performed by other suitable elements or systems. In many embodiments, the elements, components, and systems of cross-channel experimentation system 310, web server 320, and physical stores system 525 can be modules of computing instructions (e.g., software modules) stored at non-transitory computer readable media. In other embodiments, the elements, components, and systems of each of cross-channel experimentation system 310, web server 320, and physical stores system 525 can be implemented in hardware.

In many embodiments, cross-channel experimentation system 310 can include a communication system 511. In a number of embodiments, communication system 511 can at least partially perform block 405 (FIG. 4) of receiving, from a user, one or more pre-designed test parameters of an experiment designed to test at least one marketing strategy for at least one marketing channel.

In several embodiments, cross-channel experimentation system 310 also can include a splitting system 512. In various embodiments, splitting system 512 can at least partially perform block 445 (FIG. 4) of, before evaluating whether pre-existing bias exists, randomizing the members remaining in the audience by splitting the audience list table into the two or more treatment groups.

In many embodiments, cross-channel experimentation system 310 further can include an audience system 513. In several embodiments, audience system 513 can at least partially perform block 410 (FIG. 4) of generating a set of baseline key performance indicators (KPIs), block 415 (FIG. 4) of inputting the set of baseline KPIs and the remaining members in the audience list table, block 420 (FIG. 4) of determining, by using a statistical algorithm, a minimum sample size of the audience based on the set of baseline KPIs and the remaining members in the audience list table, and/or block 425 (FIG. 4) of generating an audience list table comprising one or more identifications (IDs) for each member of an audience, wherein the one or more IDs link to one or more identification (ID) levels.

In some embodiments, cross-channel experimentation system 310 additionally can include a mapping system 514. In many embodiments, mapping system 514 can at least partially perform block 430 (FIG. 4) of assigning the one or more IDs to the one or more ID levels, wherein the ID levels are categorized into one or more hierarchical levels in a hierarchical structure and/or block 440 (FIG. 4) of removing, using identification (ID) mapping, each member of the audience who has an ID that does not satisfy one or more constraints of the one or more ID levels based on the one or more pre-designed test parameters.

In various embodiments, cross-channel experimentation system 310 also can include an evaluation system 515. In some embodiments, evaluation system 515 can at least partially perform block 450 (FIG. 4) of evaluating, using an evaluation algorithm, whether bias exists for each treatment group of two or more treatment groups created from members remaining in the audience after removing certain members of the audience, block 455 (FIG. 4) of launching the experiment on the members remaining in the audience, block 460 (FIG. 4) of causing at least one result of the experiment to be displayed on at least one user interface of at least one user electronic device, and/or block 465 (FIG. 4) of after completing the experiment, evaluating whether the bias exists for each treatment group of the two or more treatment groups.

In several embodiments, physical stores system 525 additionally can include an In-Store Purchase Tracking System 530. In various embodiments, database system 530 can at least partially perform gathering information regarding in-store orders.

In a number of embodiments, web server 320 can include an online activity tracking system 521. In many embodiments, online activity tracking system 521 can at least partially perform gathering information regarding online orders and sending instructions to user computers (e.g., 350-351 (FIG. 3)) based on information received from communication system 511.

In various embodiments, an advantage can include an efficient use of resources in that this system can integrate all of the activities used in conducting a scientific experimentation in marketing and/or other suitable commerce area. For example, the system includes the audience list, sanity check, randomization, pre bias detection, and post evaluation, each of which is integrated to executing the experimentation system that can launch tests on the fly.

In a number of embodiments, the techniques described herein can advantageously provide a consistent user experience by dynamically utilizing an experimentation platform to launch experimental tests using a cross-channel experimentation system 310 (FIG. 3) across different applications that query this information, such as product information, etc. For example, over two million product updates can be received from third-party vendors in one day. In some embodiments, the techniques provided herein can beneficially reduce computing resources and costs while continuing to offer real time updates based on rule change events for the products received each second, minute, and/or other suitable period of time in at least a day, a week, and/or other suitable periods of time. For example, a catalog can include approximately one hundred million items and/or products at any given period of time. In many embodiments, the techniques described herein can be used continuously at a scale that cannot be handled using manual techniques. For example, the number of daily and/or monthly visits to the content source can exceed approximately ten million and/or other suitable numbers, the number of registered users to the content source can exceed approximately one million and/or other suitable numbers, and/or the number of products and/or items sold on the website can exceed approximately ten million (10,000,000) approximately each day.

Various embodiments can include a system including one or more processors and one or more non-transitory computer-readable media storing computing instructions configured to run on the one or more processors and perform certain acts. The acts can include receiving, from a user, one or more pre-designed test parameters of an experiment designed to test at least one marketing strategy for at least one marketing channel. The acts also can include generating an audience list table comprising one or more identifications (IDs) for each member of an audience. The one or more IDs can link to one or more identification (ID) levels. The acts further can include removing, using identification (ID) mapping, each member of the audience who has an ID that does not satisfy one or more constraints of the one or more ID levels based on the one or more pre-designed test parameters. The acts also can include evaluating, using an evaluation algorithm, whether bias exists for each treatment group of two or more treatment groups created from members remaining in the audience after removing certain members of the audience. The acts further can include launching the experiment on the members remaining in the audience. The acts additionally can include causing at least one result of the experiment to be displayed on at least one user interface of at least one user electronic device.

A number of embodiments can include a method being implemented via execution of computing instructions configured to run at one or more processors and stored at one or more non-transitory computer-readable media. The method can include receiving, from a user, one or more pre-designed test parameters of an experiment designed to test at least one marketing strategy for at least one marketing channel. The method also can include generating an audience list table comprising one or more identifications (IDs) for each member of an audience. The one or more IDs can link to one or more identification (ID) levels. The method additionally can include removing, using identification (ID) mapping, each member of the audience who has an ID that does not satisfy one or more constraints of the one or more ID levels based on the one or more pre-designed test parameters. The method further can include evaluating, using an evaluation algorithm, whether bias exists for each treatment group of two or more treatment groups created from members remaining in the audience after removing certain members of the audience. The method additionally can include launching the experiment on the members remaining in the audience. The method further can include causing at least one result of the experiment to be displayed on at least one user interface of at least one user electronic device.

Although automatically determining an audience pool to launch for an cross-channel experimental design has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIGS. 3-7, 10-11 may include different procedures, processes, and/or activities and be performed by many different modules, in many different orders, and/or one or more of the procedures, processes, or activities of FIGS. 3-7, 10-11 may include one or more of the procedures, processes, or activities of another different one of FIGS. 3-7, 10-11. As another example, the systems within cross-channel experimentation system 310, and/or web server 320. Additional details regarding cross-channel experimentation system 310, and/or webserver 320 (see FIGS. 3 and 6) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and perform:
receiving, from a user, one or more pre-designed test parameters of an experiment designed to test at least one marketing strategy for at least one marketing channel;
generating an audience list table comprising one or more identifications (IDs) for each member of an audience, wherein the one or more IDs link to one or more identification (ID) levels;
removing, using identification (ID) mapping, each member of the audience who has an ID that does not satisfy one or more constraints of the one or more ID levels based on the one or more pre-designed test parameters;
evaluating, using an evaluation algorithm, whether bias exists for each treatment group of two or more treatment groups created from members remaining in the audience after removing certain members of the audience;
launching the experiment on the members remaining in the audience; and
causing at least one result of the experiment to be displayed on at least one user interface of at least one user electronic device.

2. The system of claim 1, wherein the computing instructions are further configured to run on the one or more processors and perform:
assigning the one or more IDs to the one or more ID levels, wherein the ID levels are categorized into one or more hierarchical levels in a hierarchical structure,
wherein:
each ID in a higher hierarchical level maps to one or more IDs in a lower hierarchical level; and
the each ID in a lower hierarchical level maps at most to one ID in a higher hierarchical level.

3. The system of claim 2, wherein:
each hierarchical level comprises a same ID hashed in a different format; and
each ID level is linked to a particular algorithm.

4. The system of claim 2, wherein the one or more ID level comprise at least one of:
user account identification (ID) linked to historical transaction data;
an email identification (ID) linked to at least one household, wherein the at least one household comprises one or more users; or
a method of payment linked to the at least one household.

5. The system of claim 1, wherein using the ID mapping comprises:
mapping a primary key for the audience list table to each of the one or more IDs for respective members of the audience.

6. The system of claim 1, wherein the computing instructions are further configured to run on the one or more processors and perform:
generating a set of baseline key performance indicators (KPIs);
inputting the set of baseline KPIs and the remaining members in the audience list table; and
determining, by using a statistical algorithm, a minimum sample size of the audience based on the set of baseline KPIs and the remaining members in the audience list table, wherein a probability of a false positive for the minimum sample size is below 5 percent.

7. The system of claim 6, wherein a probability of a false negative for the minimum sample size is below 80 percent.

8. The system of claim 1, wherein the computing instructions are further configured to run on the one or more processors and perform:
before evaluating whether pre-existing bias exists, randomizing the members remaining in the audience by splitting the audience list table into the two or more treatment groups,
wherein randomizing comprises automatically identifying, using a randomization key, the members remaining in the audience.

9. The system of claim 1, wherein using the evaluation algorithm comprises:
inputting a respective number of success events from a first treatment group and a second treatment group;
inputting a first size of the first treatment group and a second size of the second treatment group; and
outputting a value level for evaluating whether the bias exists for the first treatment group and the second treatment group.

10. The system of claim 1, wherein the computing instructions are further configured to run on the one or more processors and perform:
after completing the experiment, repeating evaluating whether the bias exists for each treatment group of the two or more treatment groups.

11. A method being implemented via execution of computing instructions configured to run on one or more processors and stored at one or more non-transitory computer-readable media, the method comprising:
receiving, from a user, one or more pre-designed test parameters of an experiment designed to test at least one marketing strategy for at least one marketing channel;
generating an audience list table comprising one or more identifications (IDs) for each member of an audience, wherein the one or more IDs link to one or more identification (ID) levels;
removing, using identification (ID) mapping, each member of the audience who has an ID that does not satisfy one or more constraints of the one or more ID levels based on the one or more pre-designed test parameters;
evaluating, using an evaluation algorithm, whether bias exists for each treatment group of two or more treatment groups created from members remaining in the audience after removing certain members of the audience;
launching the experiment on the members remaining in the audience; and
causing at least one result of the experiment to be displayed on at least one user interface of at least one user electronic device.

12. The method of claim 11, further comprising:
assigning the one or more IDs to the one or more ID levels, wherein the ID levels are categorized into one or more hierarchical levels in a hierarchical structure,
wherein:
each ID in a higher hierarchical level maps to one or more IDs in a lower hierarchical level; and
the each ID in a lower hierarchical level maps at most to one ID in a higher hierarchical level.

13. The method of claim 12, wherein:
each hierarchical level comprises a same ID hashed in a different format; and
each ID level is linked to a particular algorithm.

14. The method of claim 12, wherein the one or more ID level comprise at least one of:
user account identification (ID) linked to historical transaction data;
an email identification (ID) linked to at least one household, wherein the at least one household comprises one or more users; or
a method of payment linked to the at least one household.

15. The method of claim 11, wherein using the ID mapping comprises:
mapping a primary key for the audience list table to each of the one or more IDs for respective members of the audience.

16. The method of claim 11, further comprising:
generating a set of baseline key performance indicators (KPIs);
inputting the set of baseline KPIs and the remaining members in the audience list table; and
determining, by using a statistical algorithm, a minimum sample size of the audience based on the set of baseline KPIs and the remaining members in the audience list table, wherein a probability of a false positive for the minimum sample size is below 5 percent.

17. The method of claim 16, wherein a probability of a false negative for the minimum sample size is below 80 percent.

18. The method of claim 11, further comprising:
before evaluating whether pre-existing bias exists, randomizing the members remaining in the audience by splitting the audience list table into the two or more treatment groups,
wherein randomizing comprises automatically identifying, using a randomization key, the members remaining in the audience.

19. The method of claim 11, wherein using the evaluation algorithm comprises:
inputting a respective number of success events from a first treatment group and a second treatment group;
inputting a first size of the first treatment group and a second size of the second treatment group; and
outputting a value level for evaluating whether the bias exists for the first treatment group and the second treatment group.

20. The method of claim 11, further comprising:
after completing the experiment, repeating evaluating whether the bias exists for each treatment group of the two or more treatment groups.
